(19) United States
(12) Patent Application Publication
(10) Pub. No.: US 2024/0095191 A1
(43) Pub. Date: Mar. 21, 2024

(54) PAIRING METHOD BETWEEN A HOST DEVICE AND A PERIPHERAL DEVICE

(71) Applicants: STMicroelectronics (Rousset) SAS, Rousset (FR); Proton World International N.V., Diegem (BE)

(72) Inventors: Denis FARISON, Le Tholonet (FR); Joris DELCLEF, Aaigem (BE)

(73) Assignees: STMicroelectronics (Rousset) SAS, Rousset (FR); Proton World International N.V., Diegem (BE)

(21) Appl. No.: 18/367,731

(22) Filed: Sep. 13, 2023

(30) Foreign Application Priority Data
Sep. 16, 2022 (FR) 2209362

(51) Int. Cl. G06F 13/10; G06F 21/44

(52) U.S. Cl. CPC G06F 13/102; G06F 21/44

(57) ABSTRACT

A method of pairing between a first host device and a first peripheral device includes entering by a user of the first host device a verification value, as well as comparing, by the first peripheral device, between the verification value and a first secret value stored in a memory of the first peripheral device. When the verification corresponds to the first secret value, the method of pairing further includes calculating and storing a first pairing key by the first host device and the first peripheral device to perform the pairing.

### PRIORITY CLAIM

This application claims the priority benefit of French Application for Patent No. 2209362, filed on Sep. 16, 2022, the content of which is hereby incorporated by reference in its entirety to the maximum extent allowable by law.

### TECHNICAL FIELD

The present disclosure generally concerns the field of the pairing between two devices, more particularly between a host device and a peripheral device.

### BACKGROUND

In certain applications, the operation of a device is conditioned to the coupling with a peripheral device. This is, for example, the case for electric vehicles, or also electric scooters, etc., for which a battery is connected to power the vehicle and allow its operation. This is also, for example, the case for automobiles for which parts or peripherals capable of being detached allow the operation certain pieces of equipment.

However, the peripheral device is generally expensive and is theft prone. There exists a technical issue to protect such peripheral devices from theft without adding additional technical constraints to a user.

There is a need to improve the protection of peripheral devices allowing the operation of other devices.

There is a need to overcome all or part of the disadvantages of known protection methods.

### SUMMARY

In an embodiment, a pairing method between a first host device and a first peripheral device comprises: entering in the first peripheral device, by a user of the first host device, a verification value; comparing, by the first peripheral device, between the verification value and a first secret value stored in a memory of the first peripheral device; and when the verification value corresponds to the first secret value, calculating and storing a first pairing key by the first host device and the first peripheral device to perform the pairing.

According to an embodiment, the method also includes, when the verification value corresponds to the first secret value, establishing a secure channel between the first peripheral device and the first host device.

According to an embodiment, the method also includes, as a result of the pairing of the first host device with the first peripheral device: placing the first peripheral device in a deactivation state; transmitting by the first host device of an activation request to the first peripheral device, based on the first pairing key; and activating the first peripheral device based on a verification of the request.

According to an embodiment, the method also includes, before keying in of the verification value, verifying the authenticity of the first peripheral device based on an authenticity value.

According to an embodiment, the first pairing key is generated in parallel by the first peripheral device and by the first host device based on the first secret value and/or on the authenticity value and is stored in a first location of a non-volatile memory of the first peripheral device and in a first location of a non-volatile memory of the first host device.

According to an embodiment, the first secret value is stored in encrypted fashion in a non-volatile memory of the first peripheral device.

According to an embodiment, the verification value is a pin code.

According to an embodiment, the verification value is a NFC tag.

According to an embodiment, the first host device and the first peripheral device are coupled via an I²C-type bus.

According to an embodiment, the method also includes pairing between the first host device and a second peripheral device by: entering by a user of the first host device a verification value; comparing, by the second peripheral device, between the verification value and a second secret value stored in a memory of the second peripheral device; and when the verification corresponds to the second secret value, calculating and storing a second pairing key by the first host device and the second peripheral device to perform the pairing.

According to an embodiment, the method also includes pairing between a second host device and the first peripheral device by: entering by a user of the second host device a verification value; comparing, by the first peripheral device, between the verification value and the first secret value; and when the verification corresponds to the first secret value, calculating and storing a third pairing key by the second host device and the first peripheral device to perform the pairing.

An embodiment provides a first host device configured to: transmit to a peripheral device a verification value entered by a user; and calculate and store a pairing key to perform a pairing between the first host device and the peripheral device.

An embodiment provides a first peripheral device configured to: compare a verification value, entered by a user of a host device, with a secret value stored in a non-volatile memory of the first peripheral device; and when the verification value corresponds to the secret value, calculate and store a first pairing key to perform a pairing between the host device and the first peripheral device.

An embodiment provides a system including the above first host device and the above first peripheral device.

According to an embodiment, the system further comprises a second host device and a second peripheral device, the first peripheral device being further configured to perform a pairing with the second host device and the second peripheral device being further configured to perform a pairing with the first host device.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 is a block diagram illustrating a host device and a peripheral device according to an embodiment of the present disclosure;

FIG. 2 is a flowchart illustrating steps of a pairing method implemented by a host device according to an embodiment of the present disclosure;

FIG. 3 is a flowchart illustrating steps of a pairing method implemented by a peripheral device according to an embodiment of the present disclosure;

FIG. 4A illustrates an example of pairing between a battery and a bicycle according to an embodiment of the present disclosure;

FIG. 4B illustrates another example of pairing between a battery and a bicycle according to an embodiment of the present disclosure;

FIG. 4C illustrates still another example of pairing between a battery and a bicycle according to an embodiment of the present disclosure;

FIG. 5A is a block diagram illustrating an example of a system architecture according to an embodiment of the present disclosure;

FIG. 5B is a block diagram illustrating another example of a system architecture according to an embodiment of the present disclosure;

FIG. 5C is a block diagram illustrating still another example of a system architecture according to an embodiment of the present disclosure;

FIG. 5D is a block diagram illustrating still another example of a system architecture according to an embodiment of the present disclosure;

FIG. 6A is a block diagram illustrating an example of an authentication unit according to an embodiment of the present disclosure; and

FIG. 6B is a block diagram illustrating another example of the authentication unit according to an embodiment of the present disclosure.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the operation of the different types of encryptions used, such as symmetrical key encryptions as well as the operation of the electronic certificates are well known by those skilled in the art and have not been detailed in the following description.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made, unless specified otherwise, to the orientation of the figures.

Unless specified otherwise, the expressions “around”, “approximately”, “substantially” and “in the order of” signify within 10%, and preferably within 5%.

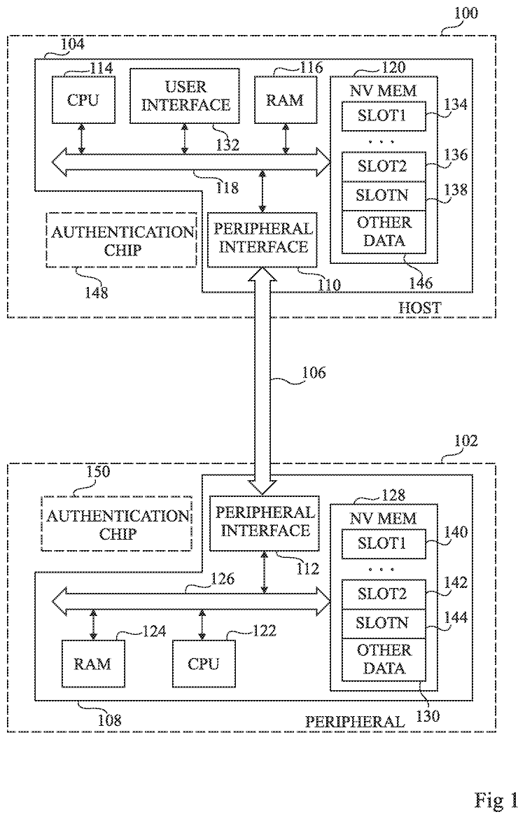

FIG. 1 is a block diagram illustrating a host device 100 (HOST) and a peripheral device 102 (PERIPHERAL) according to an embodiment of the present disclosure.

As an example, host device 100 is an electric vehicle such as an electric bicycle, an electric scooter, etc. and peripheral device 102 is the battery allowing the operation of the vehicle. In another example, host device 100 is a smart phone and peripheral device 102 is an accessory, such as, for example, wireless headphones. Still in other examples, devices 100 and 102 are spare parts of an automobile. These examples are not limiting. Generally, devices 100 and 102 are two devices which can be paired. Peripheral device 102 is, for example, under control of host device 100 at least part of the time. Further, peripheral device 102 is, for example, detachable from host device 100. In many applications, peripheral device 102 is relatively expensive, and thus even if a mechanical anti-theft mechanism is provided to prevent peripheral device 102 from being detached from host device 100, theft attempts are always a risk. As an example, in the case of electric bicycles, where host device 100 is the bicycle with its motor, and peripheral device 102 is a battery powering the motor, the value of peripheral device 102 may be in the order of half the price of host device 100.

A solution to dissuade the theft of peripheral device 102 is to make this peripheral device 102 impossible to use in other host devices. However, it is important for the theft protection of peripheral device 100 not to prevent any possibility of use of host device 100 and of peripheral device 102 by the user. As an example, the user may want to use, as an alternative, two peripheral devices 102 with a same host device 100. Similarly, the user may, for example, want to pair a same peripheral device 102 with different host devices 100. The user may also, for example, want to have the possibility of reselling a peripheral device 102 belonging to him/her.

As an example, host device 100 comprises a processing unit 104 coupled, via a bus 106, to a processing unit 108 of peripheral device 102. As an example, each processing unit 104 and 108 respectively comprises a peripheral interface 110 and 112 (PERIPHERAL INTERFACE) coupled to bus 106.

As an example, bus 106 is a bus of I²C (“Inter Integrated Circuit”) type. In another example, the coupling between processing units 104 and 108 is, for example, performed by a wireless connection, such as, for example, by Bluetooth, by near-field communication (NFC) or by wireless fidelity (WiFi) connection, where host device 100 or peripheral device 102 is, for example, the wireless hotspot.

Processing unit 104, for example, comprises a processor 114 (CPU) as well as a volatile memory 116 (RAM) coupled, for example, via a system bus 118. As an example, volatile memory 116 is a random access memory.

Processing unit 104 further comprises, for example, a non-volatile memory 120 (NV MEM), for example a Flash-type memory, coupled to system bus 118.

The processing unit 108 of peripheral device 102, for example, also comprises a processor 122 (CPU), as well as a volatile memory 124 (RAM), for example coupled via a system bus 126. As an example, volatile memory 124 is a random access memory.

Processing unit 108, for example, further comprises a non-volatile memory 128 (NV MEM) coupled to system 126. As an example, non-volatile memory 128 is a Flash-type memory.

According to an embodiment, peripheral device 102 is protected by a secret value to only be able to be used by a user knowing the secret value. As an example, the secret value is stored in an area 130 (OTHER DATA) of non-volatile memory 128.

According to an embodiment, a user of peripheral device 102 enters, for example via a user interface (USER INTERFACE) 132 comprised in processing unit 104, a verification value. The pairing between devices 100 and 102, or the putting into service of device 102, is then possible when the verification value corresponds to the secret value. As an example, the verification value takes the form of a pin code or of a password entered by the user on a keyboard of device 100 or 102, or also a code provided by a NFC tag read by device 100 or 102, or by a QR (“quick response”) code, scanned by device 100 or 102.

User interface 132, for example, takes the form of a digital or touch interface. In another example, interface 132 comprises a QR code reader. In still another example, interface 132 takes the form of a button and each digit of a pin code may, for example, be entered by repeatedly pressing, for example, four repeated pressings to codify digit 4, and, for example, by pausing between two digit entries. Although user interface 132 is illustrated as forming part of processing unit 104, in other embodiments, interface 132 may form part of a different device in communication with processing units 104 and/or 108. For example, interface 132 is a mobile device, such as, for example, a smart phone, coupled to processing unit 104 and/or 108 via a communication link, such as, for example, a WiFi link, or a NFC link, etc. The mobile device then, for example, executes an application communicating a verification value to processing unit 104 and/or 108 via the communication link. It is also possible for interface 132 to form part of peripheral device 102.

According to an embodiment, when a user couples two devices 100 and 102 which have not been paired yet, a verification is, for example, performed on the verification value. As an example, the coupling between devices 100 and 102 corresponds to a connection of peripheral device 102 to host device 100. For example, the battery of an electric bicycle is placed in a dedicated location of the electric bicycle, the connection further allowing the power supply of the bicycle when the pairing procedure has succeeded. In another example, the coupling corresponds to the establishing of a Bluetooth link, between host device 100 and peripheral device 102. In other examples, the coupling between host device 100 and peripheral device 102 is performed automatically when, for example, the two devices 100 and 102 are nearby.

If the verification value effectively corresponds to the secret value, devices 100 and 102 are configured to generate one or a plurality of pairing keys. As an example, non-volatile memory 120 comprises locations 134, 136, and 138 (SLOT1, SLOT2, and SLOTN) and non-volatile memory 130 comprises locations 140, 142, 144 (SLOT1, SLOT2, SLOT N). Each location is, for example, configured to store a pairing key.

According to an embodiment, peripheral device 102 is identified in unique fashion by an identifier. In other words, two distinct peripheral devices are each identified by a different identifier. As an example, the identifier forms part of an electronic certificate for example stored in the area 130 of peripheral device 102. On the side of host device 100, locations 134, 136, and 138 are, for example, configured to store, in addition to the pairing keys, the identifier of the corresponding peripheral device.

According to an embodiment, non-volatile memory 120 further comprises an area 146 (OTHER DATA). Areas 130 and 146, for example, store keys and/or electronic certificates enabling host device 100 to authenticate peripheral device 102. For example, the electronic certificate includes an identifier specific to peripheral device 102. As an example, the authentication is performed by device 100 for each device 102 to which it is coupled but not paired. The authentication of peripheral device 102 is, for example, performed before the user enters the verification value. As an example, in the case where the authentication fails, bus 106 is configured to inhibit the operation of the assembly formed by devices 100 and 102.

Memory areas 130 and 146, for example, further store computer codes containing instructions for the operation of processing units 104 and 108. These instructions are, for example, respectively loaded into volatile memories 116 and 124 and executed by processors 114 and 122.

As an alternative, host device 100 and/or peripheral device 102 further respectively comprise an authentication unit 148 and/or 150 (AUTHENTICATION CHIP). Authentication units 148 and 150 are, for example, respectively coupled to the processing units 114 and 122 of devices 100 and 102 via dedicated buses, such as, for example, buses of I²C (Inter Integrated Circuit) type. In certain cases, authentication unit 148 comprises locations configured to store pairing keys at locations 134 to 138 and/or 146 in non-volatile memory 120. As an example, each location of authentication unit 148 is further configured to store, in addition to a pairing key, the identifier of the paired peripheral device. Similarly, in certain cases, authentication unit 150 comprises locations configured to store pairing keys at locations 140 to 144 and/or 130 in non-volatile memory 128. Authentication units 148 and 150 are, for example, further configured to store the keys and/or the electronic certificates enabling host device 100 to authenticate peripheral device 102. As an example, authentication units 148 and 150 are further configured to execute cryptographic operations, for example, using the pairing keys and/or the private keys and electronic certificates.

As an alternative, instead of being stored in area 130, the secret value comprised in peripheral device 102 is stored in another memory location, for example, a location of authentication unit 150.

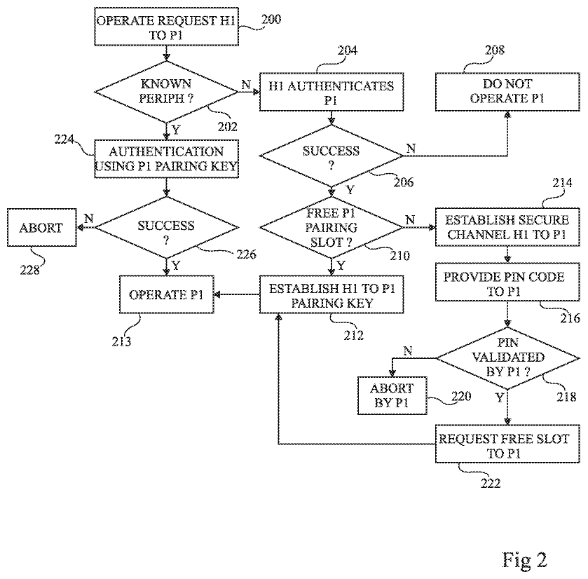

FIG. 2 is a flowchart illustrating steps of a pairing method implemented by host device 100 according to an embodiment of the present disclosure.

At a step 200 (OPERATE REQUEST H1 TO P1), host device 100 initiates an operating request to peripheral device 102. As an example, step 200 follows the coupling between devices 100 and 102. Although 100 and 102 are capable of communicating, peripheral device 102 is in a non active state, which does not allow the use of devices 100 and 102 by the user. As an example, an electric battery in a non-active state does no power the electric bicycle to which it is coupled.

At a step 202 (KNOWN PERIPH?), host device 100 verifies whether peripheral device 102 has already been paired. As an example, host device 100 verifies whether a location of non-volatile memory 120, or as an alternative of authentication unit 148, comprises a key allowing the pairing with peripheral device 102. For example, each time host device 100 is paired with a peripheral device such as peripheral 102, an identifier of the peripheral device is stored in a non-volatile memory of the host device 100 in association with the pairing key. When a peripheral device is attached to host device 100, the latter reads the identifier of the peripheral and verifies in the concerned volatile memory whether an already-stored identifier corresponds. When the read identifier corresponds to an identifier already stored in the host device, this indicates that the peripheral has already been paired with host device 100. In the case where the identifier corresponds to none of the identifiers stored in host device 100, this indicates that the peripheral device has not been paired yet with host device 100. If it is determined, at step 202, that peripheral device 102 is not known (branch N), the method continues at a step 204 (H1 AUTHENTICATES P1).

Step 204 comprises a verification of the authenticity of peripheral device 102. As an example, the verification of the authenticity of peripheral device 102 is performed by using an electronic certificate, delivered by a certification authority, and a private key, stored in non-volatile memory 128 or, as an alternative, in authentication unit 150.

As an example, the authentication of host device 102 is performed according to a public key authentication (PKA) and according to a challenge-response mechanism. Peripheral device 102, for example, comprises a pair of public-private keys as well as a certificate. The certificate is, for example, generated and stored upstream, for example during the manufacturing of peripheral device 102. Host device 100, for example, receives the public key of peripheral device 102 during the first pairing. The authenticity of peripheral device 102 is then verified by host device 100 by its public key stored at location 146 or in authentication unit 148. More particularly, host device 100, for example, sends a challenge to peripheral device 102. Processor 122 ciphers the challenge using the private key and transmits a digital signature to host device 100. Host device 100 then uses its public key to verify the digital signature. In the case where peripheral device 102 is not authentic, the private key that it comprises, for example, does not correspond to the public key of host device 100 and the authentication of peripheral device 102 by host device 100 fails.

As an example, at a step 206 (SUCCESS?), the processor 114 of host device 100 determines whether peripheral device 102 has been successfully authenticated. If not (branch N), the method, for example, ends at a step 208 (DO NOT OPERATE P1) where peripheral device 102 remains in the non-active state.

If, at step 206, it is determined that peripheral device 102 is authentic (branch Y), the method continues at a step 210 (FREE P1 PAIRING SLOT?). As an example, at step 210, host device 100 sends a request to peripheral device 102 to determine whether at least one of the locations 140 to 144 of non-volatile memory 128, or, as an alternative, a location of processing unit 150, is free.

If it is determined that a location of peripheral device 102 is free (branch Y), the method continues at a step 212 (ESTABLISH H1 TO P1 PAIRING KEY). As an example, at step 212, processor 114 generates a pairing key and stores it into non-volatile memory 120 or in authentication unit 148. As an example, the pairing key is generated in parallel, by host device 100 and by peripheral device 102, via a key agreement protocol, such as, for example, a Diffie-Hellman key agreement mechanism. In another example, the pairing key is generated by an asymmetrical protocol, for example of Master Key/Base Key type. As an example, step 212 further comprises the pairing of peripheral device 102 with host device 100.

At a step 213 (OPERATE P1), host device 100 places peripheral device 102 in active mode. As an example, in the case where peripheral device 102 is a battery and host device 100 is an electric bicycle, step 214 includes the powering of the electric bicycle by the battery.

If, during step 210, it is determined that peripheral device 102 comprises no free location (branch N), the method continues at a step 214 (ESTABLISH SECURE CHANNEL H1 TO P1). As an example, a secure channel coupling host device 100 to peripheral device 102 is established at step 214.

At a step 216 (PROVIDE PIN CODE TO P1), a verification value is entered by the user, for example in host device 100, and is, for example, transmitted to peripheral device 102 via the secure channel. In another example, the verification value is directly entered into peripheral device 102 by the user.

The verification value is then compared, at a step 218 (PIN VALIDATED BY P1?), with the secret value stored in peripheral device 102. As an example, the verification is performed by the processor 122 of peripheral device 102.

If the entered verification value does not correspond to the secret value of peripheral device 102 (branch N), the method ends at a step 220 (ABORT BY P1) where peripheral device 102 interrupts the pairing method, and device 102 remains in the non-active state. The method, for example, resumes at step 216, giving a new chance to the user to enter the right verification value. As an example, when the verification value is at values in a space of limited size, such as, for example, a pin code, host device 100 is configured to block peripheral device 102 after an upstream-determined number of verification failures.

In another example, when the verification value is at values in a space of large size, such as, for example, a QR code or a NFC tag represented by 128 bits and likely to take 2¹²⁸ different values, the risk of a fraudulent pairing by scanning of the set of possible values is low. Accordingly, the number of implementations of step 220 is, for example, not limited by host device 100.

If, during step 218, the verification value is validated by peripheral device 102 (branch Y), the method continues at a step 222 (REQUEST FREE SLOT TO P1). As an example, during step 222, host device 100 sends a request to peripheral device 102 so that it makes a memory location of non-volatile memory 122 or of authentication unit 150 available, for example by removing the content of an existing location.

The method then continues in a new implementation of step 212. Processor 114, for example, generates a pairing key and stores it into non-volatile memory 120 or, as an alternative, into authentication unit 148. In another example, the pairing key is generated in parallel, by processors 114 and 122, via a Diffie-Hellman-type key agreement protocol or via any other protocol allowing the generation of a pairing key.

In the case where, after the implementation of step 202, it is determined that peripheral device 102 is already paired with host device 100, the method continues at a step 224 (AUTHENTICATION USING P1 PAIRING KEY). As an example, step 224 includes a verification of the pairing key by host device 100. For example, in certain cases, this verification is performed by a challenge-response authentication. Host device 100 transmits a challenge, corresponding to a value encrypted using the pairing key generated in an implementation of step 212 during a preceding implementation of the pairing method, to peripheral device 102. Peripheral device 102 is then configured to modify the value of the challenge, by using a key of pairing with the host device 100 which is specific thereto and return this modified value as a response to host device 100.

Processor 114 verifies, at a step 226 (SUCCESS?), whether the response returned by peripheral device 102 is effectively that expected. If this is the case (branch Y), the authentication has succeeded, and the method ends in an implementation of step 213. In the case where the authentication is a failure (branch N), the method ends at a step 228 (ABORT) where peripheral device 102 remains in the non-active state.

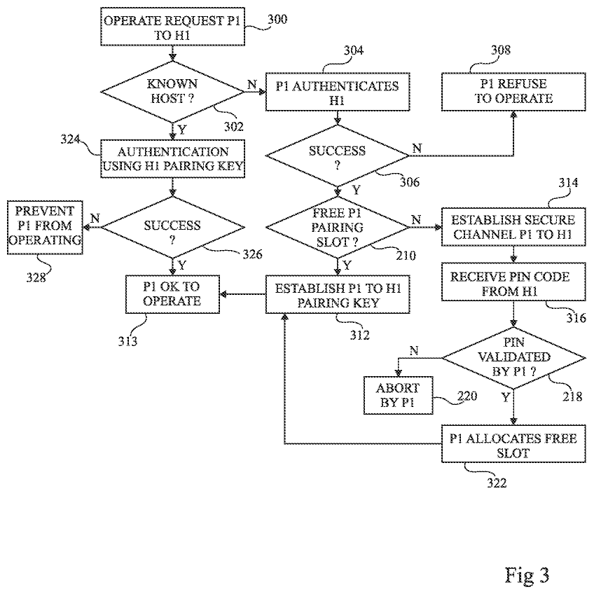

FIG. 3 is a flowchart illustrating steps of the pairing method which are implemented by peripheral device 102 according to an embodiment of the present disclosure. As an example, this method is implemented in parallel with the pairing method implemented by host device 100 and described in relation with FIG. 2.

At a step 300 (OPERATE REQUEST P1 TO H1), peripheral device 102 is in the non-active state and initiates a request to peripheral device 102 to switch to the active state. As an example, step 300 follows the coupling between devices 100 and 102 and is, for example, carried out as a response to step 200.

At a step 302 (KNOWN HOST?), peripheral device 102 verifies whether host device 100 has already been paired. As an example, peripheral device 102 verifies whether a location of non-volatile memory 128, or as an alternative of authentication unit 150, comprises a key allowing the pairing with host device 100.

If it is determined, at step 302, that host device 100 is not known (branch N), the method continues at a step 304 (P1 AUTHENTICATES H1).

Step 304 comprises a verification of the authenticity of host device 100. As an example, the verification of the authenticity of host device 100 is performed by using an electronic certificate, delivered by a certification authority, and a private key, stored in non-volatile memory 120 or, as an alternative, in authentication unit 148.

As an example, at a step 306 (SUCCESS?), the processor 122 of peripheral device 102 determines whether host device 100 has been successfully authenticated. If this is not the case (branch N), the method, for example, ends at a step 308 (P1 REFUSE TO OPERATE) where peripheral device 102 remains in the non-active state.

If, at step 306, it is determined that host device 100 is authentic (branch Y), the method continues by the implementation of step 210 (FREE P1 PAIRING SLOT?).

If it is determined that a location of peripheral device 102 is free (branch Y), the method continues at a step 314 (ESTABLISH P1 TO H1 PAIRING KEY). As an example, at step 314, processor 122 generates a pairing key and stores it into non-volatile memory 128 or into authentication unit 150. As an example, the pairing key is generated in parallel, by host device 100 and by peripheral device 102, via a Diffie-Hellman key agreement protocol or via any protocol allowing the generation of a pairing key. As an example, step 312 is carried out in parallel with step 212 and further comprises the pairing of devices 100 and 102.

At a step 313 (P1 OK TO OPERATE), peripheral device 102, for example, informs host device 100 that it is ready to switch to the active state. As an example, the step 213 described in relation with FIG. 2 is executed directly as a response to the execution of step 313.

If, during step 210, it is determined that peripheral device 102 comprises no free location (branch N), the method continues at a step 314 (ESTABLISH SECURE CHANNEL P1 TO H1). As an example, a secure channel coupling peripheral device 102 to host device 100 is established at step 314.

At a step 316 (RECEIVE PIN CODE TO P1), the verification value entered by the user during step 216 is received by peripheral device 102 via the secure channel.

The verification value is then compared, in the implementation of step 218 described in relation with FIG. 2.

If the entered verification value does not correspond to the secret value of peripheral device 102 (branch N), the method ends at a step 220 and device 102 remains in the non-active state. In another example, the method resumes at step 316, giving a new chance to the user to enter the right verification value.

If, during step 218, the verification value is validated by peripheral device 102 (branch Y), the method continues at a step 322 (P1 ALLOCATES FREE SLOT). As an example, step 322 is carried out as a response to step 222.

The method then continues in an implementation of step 312.

In the case where, as a result of the implementation of step 302, it is determined that host device 100 is already paired with peripheral device 102, the method continues at a step 324 (AUTHENTICATION USING H1 PAIRING KEY). As an example, step 324 is carried out in parallel with step 224 and includes verification of the pairing key by peripheral device 102. For example, in certain cases, this verification is performed by a challenge-response authentication. Peripheral device 102 transmits a challenge, corresponding to a value encrypted the pairing key generated in an implementation of step 312 during a preceding implementation of the pairing method, to host device 100. Host device 100 is then configured to modify the value of the challenge, by using a pairing key generated in an implementation of step 212, and return this modified value as a response to peripheral device 102.

Processor 122 verifies, at a step 326 (SUCCESS?), whether the response returned by host device 100 is effectively that expected. If this is the case (branch Y), the authentication has succeeded, and the method ends in an implementation of step 313. In the case where the authentication is a failure (branch N), the method ends at a step 328 (PREVENT P1 FROM OPERATING) where peripheral device 102 is kept in the non-active state.

Although authentication steps 204 and 304 have been written, step 304 may be omitted in certain embodiments. Peripheral device 102 is then authenticated. In this case, host device 100, for example, comprises no electronic certificates.

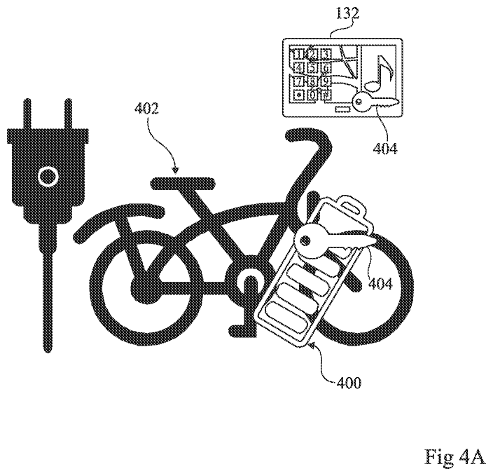

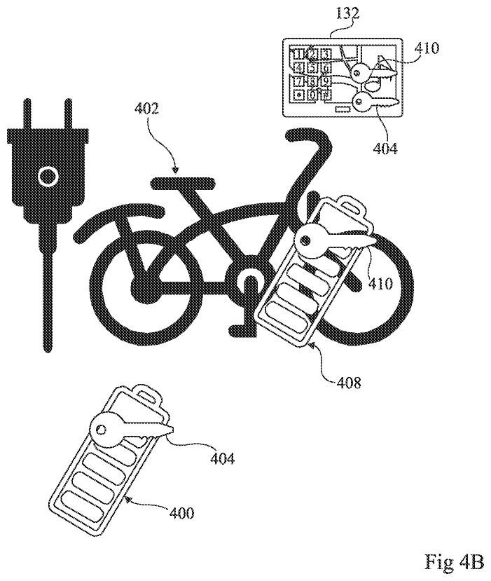

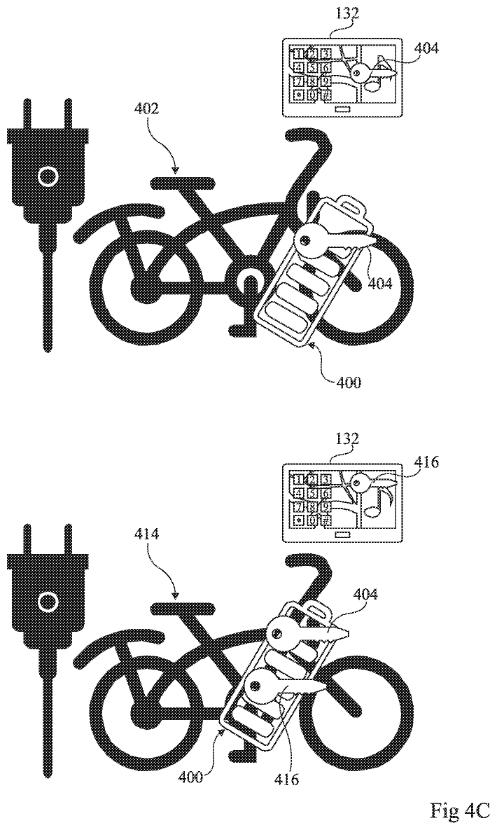

FIGS. 4A, 4B, and 4C illustrate cases of use and of pairing between host devices and peripheral devices. In particular, these drawings illustrate an example of pairing between a battery 400 corresponding to peripheral device 102 and a bicycle 402 corresponding to host device 100 (FIG. 4A), between a battery 408 corresponding to another peripheral device 102 and bicycle 402 (FIG. 4B), and between battery 400 and another bicycle 414 (FIG. 4C) according to an embodiment of the present disclosure. Those skilled in the art will be capable of adapting this example to other types of host device 100 and/or of peripheral device 102.

In the example of FIG. 4A, bicycle 402 comprises a graphic implementation of interface 132, for example in the form of a touch screen. For example, the touch screen may be further used as an interface for a GPS application and/or for an audio application. As an example, the verification value takes the form of a pin code capable of being keyed in via a digital keyboard displayed on the touch screen when a battery is inserted into bicycle 402 but has not been paired to bicycle 402 yet.

As an example, battery 400 has previously been authenticated by electric bicycle 402 in an implementation of the step 204 of FIG. 2.

The user of bicycle 402 has, for example, entered on interface 132 the verification value corresponding to the secret value stored in a non-volatile memory or, as an alternative, in the authentication unit 150 of battery 400.

According to an embodiment, battery 400 and/or bicycle 402 are configured to generate at least one pairing key in implementations of the steps 212 and 312 of FIGS. 2 and 3. A pairing key 404 is then stored in a location of the non-volatile memory 120, or of the authentication unit 148, of bicycle 402 as well as in a location of the non-volatile memory 128, or of the authentication unit 150, of battery 400.

As an example, key 404 is generated via a Diffie-Hellman-type key agreement protocol, or via another protocol allowing the generation of a pairing key.

FIG. 4B illustrates an example of pairing between a new battery 408 and bicycle 402 according to an embodiment of the present disclosure.

As an example, bicycle 402 is still paired with battery 400 and the user of bicycle 402 wishes to pair it with the new battery 408. The user may, for example, want to be able to use a second battery on his/her bicycle when the first one is discharged or charging.

As an example, the private key and the electronic certificate stored in battery 408 differ from those stored in battery 400.

The secret value stored in battery 408 is, for example, different from the secret value stored in battery 400. Thus, during the implementation of step 216 of FIG. 2, the user, for example, enters a new pin code on the interface 132 of bicycle 402. If the pin code effectively corresponds to the secret value associated with battery 408, bicycle 402 and battery 400 store a pairing key 410.

Bicycle 402 then stores two different pairing keys 404 and 410. Key 404 enables bicycle 402 to be used in association with battery 400 and key 410 enables bicycle 402 to be used in association with battery 408.

FIG. 4C illustrates an example of pairing between battery 400 and a new bicycle 414 according to an embodiment of the present disclosure.

As an example, battery 400 is still paired with bicycle 402 and a user of battery 400 wishes to pair it with the new bicycle 414.

The user for example enters, on interface 132 of the new bicycle 414, the pin code corresponding to the secret value stored in the non-volatile memory 128, or in the authentication unit 150, of battery 400. A new pairing key 416 is then stored in bicycle 414 and in battery 400. Bicycle 414 is then, for example, only paired with battery 400 while battery 400 is paired with bicycles 402 and 414.

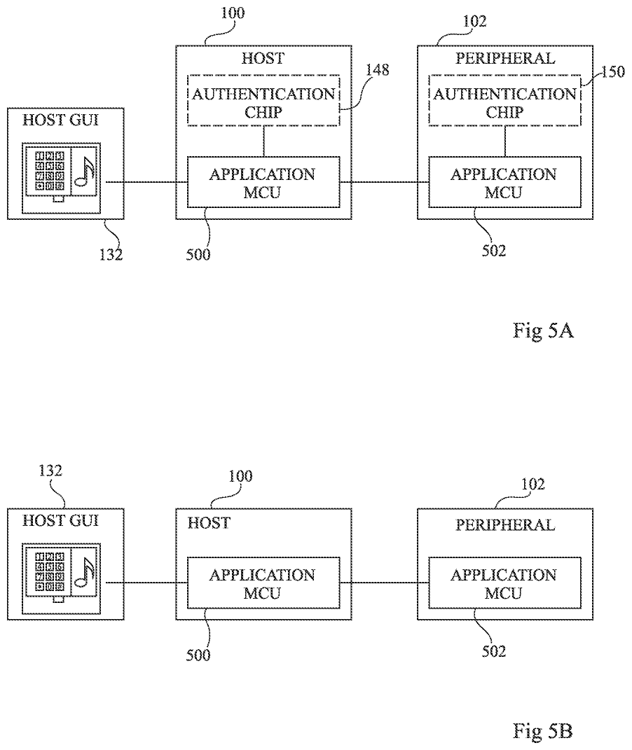

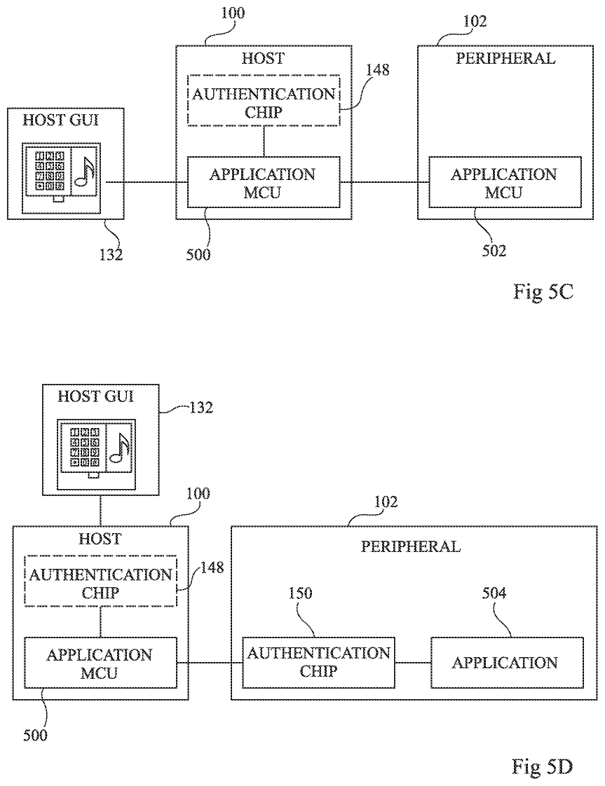

FIGS. 5A to 5D illustrate examples of a system architecture of devices 100 and 102.

In the example illustrated in FIG. 5A, host device (HOST) 100 comprises authentication unit (AUTHENTICATION CHIP) 148 and peripheral device (PERIPHERAL) 102 comprises authentication unit (AUTHENTICATION CHIP) 150. Authentication units 148 and 150, for example, store the private keys and electronic certificates as well as the pairing keys generated at the steps 212 and 312 respectively described in relation with FIGS. 2 and 3. Authentication 150 unit further stores the secret value associated with peripheral device 102.

The non-volatile memory 120 of host device 100, for example, stores application codes 500 (APPLICATION MCU). Application codes 500, for example, comprise instructions, which when they are loaded into volatile memory 116, control the execution by processor 114 of the steps 200 to 228 described in relation with FIG. 2.

The non-volatile memory 128 of peripheral device 102, for example, stores other application codes 502 (APPLICATION MCU). Application codes 502, for example, comprise instructions, which when they are loaded into volatile memory 124, control the execution by processor 122 of the steps 300 to 328 described in relation with FIG. 3.

Codes 500 and 502 are, for example, configured to control the sending of requests to units 148 and 150 so that the latter communicate the private keys and/or the certificates during the implementation of authentication steps 204 and 304. Codes 500 and 502 are, for example, further configured to control the storage of the pairing keys in units 148 and 150 during the implementation of step 212. Codes 500 and 502 are, for example, further configured to control the sending of requests to units 148 and 150 so that the latter communicate the pairing keys to processors 114 and 122 during the implementation of steps 224 and 324.

In the example illustrated in FIG. 5B, host device 100 does not comprise authentication unit 148 and peripheral device 102 does not comprise authentication unit 50. The pairing keys are then stored at locations 134 to 138 of non-volatile memory 120 and at locations 140 to 144 of non-volatile memory 128. Private keys and certificates are, for example, stored in areas 130 and 146. Further, area 130 stores the secret value associated with peripheral device 102.

The steps 200 to 228 and 300 to 328 described in relation with FIGS. 2 and 3 are then executed by processors 114 and 122 during the execution of the corresponding codes 500 and 502. Codes 500 and 502 are then configured to command from non-volatile memories 120 and 128 the provision, to processors 114 and 122, of the pairing keys and/or private keys and/or certificate and/or of the secret value.

In the example illustrated in FIG. 5C, the system architecture of host device 100 is identical to that described in relation with FIG. 5A. The system architecture of peripheral device 102 is identical to that described in relation with FIG. 5B.

Thus, the pairing keys, the private keys and certificates of host device 100 are stored in authentication unit 148. The pairing keys, the private keys and certificates of peripheral device 102 are stored in non-volatile memory 128.

In the example illustrated in FIG. 5D, the system architecture of host device 100 is identical to that described in relation with FIG. 5A. Peripheral device 102, for example, does not comprise processing unit 108. The pairing keys, private keys, and certificates of peripheral device 102 are then stored in authentication unit 150.

The application codes 500 of host device 100 are then configured to communicate with authentication units 148 and 150 to control the delivery of the pairing keys, of the private key and of the certificate to processor 114.

In the example illustrated in FIG. 5D, the steps 304 and 324 described in relation with FIG. 3 are, for example, omitted. Steps 218 and 312 are, for example, carried out by processor 114.

Peripheral device 102 further comprises an element 504 (APPLICATION) configured to place device 102 in the active state or leave it in the non-active state. As an example, element 504 is software configured to control a switch which, when it is off, places peripheral device 102 in the non-active state and which, when it is on, places device 102 in the active state.

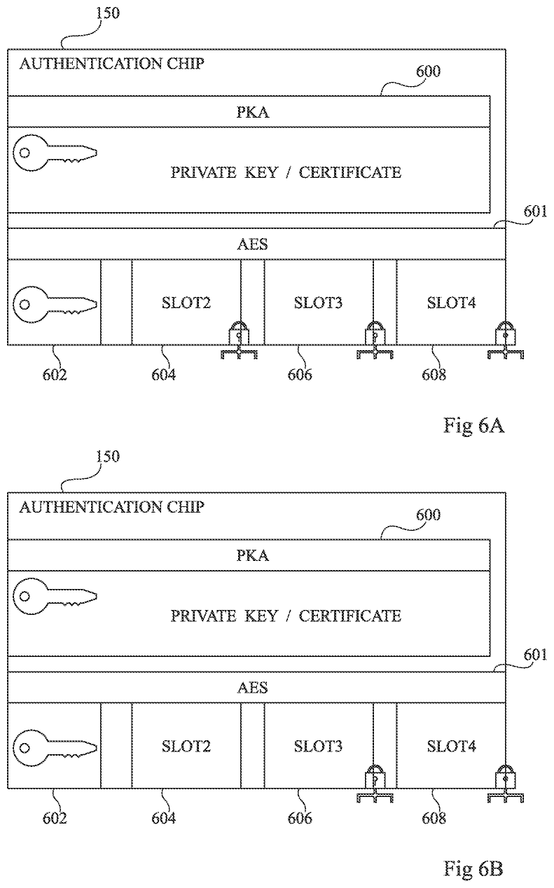

FIGS. 6A and 6B are block diagrams illustrating examples of authentication unit 150 (AUTHENTICATION CHIP) according to an embodiment of the present disclosure.

In particular, authentication unit 150 comprises a public key authentication (PKA) circuit 600. Circuit 600, for example, comprises a non-volatile memory configured to store the private keys and the certificates (PRIVATE KEY/CERTIFICATE), for example, used for the authentication of host device 100 and/or of peripheral device 102. As an example, the authentication of host device 100 and/or of peripheral device 102 is a public key authentication (PKA).

Authentication unit 150 comprises an AES cipher circuit 601 having a non-volatile memory comprising locations 602, 604 (SLOT2), 606 (SLOT3), and 608 (SLOT4) configured to store the pairing keys. As an example, location 602 stores a pairing key with a host device 100 while locations 604 to 608 are empty. Although the authentication unit 150 illustrated in FIGS. 6A and 6B comprises four locations, an authentication unit 150 may, for example, comprise a higher number of memory locations configured to store the pairing keys. As an example, authentication unit 150 may comprise several hundreds of locations.

As an example, the pairing keys are used in symmetrical encryption operations, such as, for example, operations of an AES-type algorithm.

In the example illustrated in FIG. 6A, locations 604 to 608 are, for example, locked. As an example, one of locations 604 to 608 is unlocked in an implementation of step 322 as a result of the keying in, by the user, of a correct verification value.

In another example, locations 604 to 608 already store pairing keys. A pairing of device 102 with a new device 100, for example, causes the removal of one of the keys stored in one of locations 604 to 608.

FIG. 6B illustrates authentication unit 150 where location 604 has been unlocked. Location 604 is then considered as being free and a new pairing key may be stored therein.

According to an embodiment, the content of locations 602 to 608 may be reset. As an example, the locations are reset when peripheral device 102 is handed over to a new user.

An advantage of the described embodiments is that they only enable a user knowing the secret value to pair device 102 to host device 100. Similarly, a host device 100 may be simultaneously paired with a plurality of peripheral devices 102. Similarly, a peripheral device 102 may be paired, simultaneously, with a plurality of host devices 100. The described embodiments, for example, introduce no constraint of use, other than the inserting of a verification value at the first pairing between a host device and a peripheral device.

Various embodiments and variants have been described. Those skilled in the art will understand that certain features of these various embodiments and variants may be combined, and other variants will occur to those skilled in the art. In particular, the techniques of authentication of devices 100 and 102 may vary.

Finally, the practical implementation of the described embodiments and variants is within the abilities of those skilled in the art based on the functional indications given hereabove, in particular, concerning the system architectures of the host and peripheral devices. Similarly, the number of pairing keys that can be stored in the host and peripheral devices may vary, for example, according to the use of the devices. The implementation of the user interface may also vary.

1. A method of pairing between a first host device and a first peripheral device, comprising:
receiving a verification value, at the first peripheral device, entered by a user of the first host device;
comparing the verification value and a first secret value stored in a memory of the first peripheral device, using the first peripheral device; and
when the verification value corresponds to the first secret value, generating and storing a first pairing key by the first host device and the first peripheral device.

2. The method according to claim 1, further comprising, when the verification value corresponds to the first secret value, establishing a secure channel between the first peripheral device and the first host device.

3. The method according to claim 1, further comprising, following the pairing of the first host device with the first peripheral device:
placing the first peripheral device in a deactivation state;
transmitting an activation request to the first peripheral device, based on the first pairing key, using the first host device; and
activating the first peripheral device based on a verification of the request.

4. The method according to claim 1, further comprising, before entry of the verification value by the user, authenticating the first peripheral device based on an authenticity value.

5. The method according to claim 4, wherein the first pairing key is generated in parallel by the first peripheral device and by the first host device based on the first secret value and is stored in a first location of a non-volatile memory of the first peripheral device and in a first location of a non-volatile memory of the first host device.

6. The method according to claim 4, wherein the first pairing key is generated in parallel by the first peripheral device and by the first host device based on the authenticity value and is stored in a first location of a non-volatile memory of the first peripheral device and in a first location of a non-volatile memory of the first host device.

7. The method according to claim 4, wherein the first pairing key is generated in parallel by the first peripheral device and by the first host device based on the first secret value and the authenticity value and is stored in a first location of a non-volatile memory of the first peripheral device and in a first location of a non-volatile memory of the first host device.

8. The method according to claim 1, further comprising storing the first secret value in encrypted fashion in a first non-volatile memory of the first peripheral device.

9. The method according to claim 1, wherein the verification value is a pin code.

10. The method according to claim 1, wherein the verification value is a NFC tag.

11. The method according to claim 1, wherein the first host device and the first peripheral device are coupled via an I²C-type bus.

12. The method according to claim 1, further pairing the first host device and a second peripheral device by:
receiving a verification value, at the first host device, entered by a user of the first host device;
comparing the verification value and a second secret value stored in a memory of the second peripheral device, using the second peripheral device; and
when the verification value corresponds to the second secret value, generating and storing a second pairing key by the first host device and the second peripheral device.

13. The method according to claim 1, further comprising pairing between a second host device and the first peripheral device by:
receiving a verification value, at the second host device, entered by a user of the second host device;
comparing the verification value and the first secret value, using the first peripheral device; and
when the verification value corresponds to the first secret value, generating and storing a third pairing key by the second host device and the first peripheral device to perform the pairing.

14. A host device, comprising:
a peripheral interface configured to transmit a verification value entered by a user to a peripheral device; and
a central processing unit configured to generate and store a pairing key to perform a pairing between the first host device and the peripheral device.

15. A first peripheral device, comprising:
a central processing unit configured to:
compare a verification value, entered in the first peripheral device by a user of a host device, with a secret value stored in a non-volatile memory of the first peripheral device; and
when the verification value corresponds to the secret value, generate and store a first pairing key to perform a pairing between the host device and the first peripheral device.

16. A system, comprising:
a host device, comprising:
a peripheral interface configured to transmit a verification value entered by a user to a peripheral device; and
a central processing unit configured to generate and store a pairing key to perform a pairing between the first host device and the peripheral device; and
a first peripheral device comprising a central processing unit configured to:
compare a verification value, entered by a user of a host device, with a secret value stored in a non-volatile memory of the first peripheral device; and
when the verification value corresponds to the secret value, generate and store a first pairing key to perform a pairing between the host device and the first peripheral device.

17. The system according to claim 16, further comprising a second host device and a second peripheral device, the first peripheral device being further configured to perform a pairing with the second host device and the second peripheral device being further configured to perform a pairing with the first host device.
